(19) United States
(12) Patent Application Publication
(10) Pub. No.: US 2025/0098913 A1
(43) Pub. Date: Mar. 27, 2025

(54) Vacuum Cleaner

(71) Applicant: SUZHOU ALTON ELECTRICAL & MECHANICAL INDUSTRY CO., LTD., Suzhou, Jiangsu (CN)

(72) Inventors: Weidong LU, West Chicago, IL (US); Jinbo LIU, Suzhou, Jiangsu (CN); Menghuan ZHANG, Suzhou, Jiangsu (CN); Shuhua SANG, Suzhou, Jiangsu (CN)

(21) Appl. No.: 18/725,772

(22) PCT Filed: Nov. 23, 2022
(86) PCT No.: PCT/CN2022/133725

§ 371 Date: Jun. 30, 2024

(30) Foreign Application Priority Data
Dec. 31, 2021 (CN) 202111672536.4

(51) Int. Cl. A47L 9/00; A47L 5/36; A47L 9/14; H02K 5/20; H02K 5/24; H02K 9/06

(52) U.S. Cl. CPC A47L 9/0081; A47L 5/365; A47L 9/1463; H02K 5/207; H02K 5/24; H02K 9/06

(57) ABSTRACT

A vacuum cleaner is provided with a motor, and an impeller driven by the motor to rotate so as to generate suction airflow. The vacuum cleaner is further provided with an exhaust air duct, an air window wall for ventilation, a first noise reducer which is breathable, and a second noise reducer which is breathable. A tail end of the exhaust air duct is provided with an air duct outlet for air exhaust of the exhaust air duct, the air window wall is located downstream of the air duct outlet, the first noise reducer blocks the exhaust air duct, the second noise reducer is covered with an inner side of the air window wall, and an airflow discharged by the impeller flows through the exhaust air duct and sequentially passes through the first noise reducer, the second noise reducer, and the air window wall.

### CROSS-REFERENCE TO RELATED APPLICATION

The disclosure is a National Stage Filing of the PCT International Application No. PCT/CN2022/133725 filed on Nov. 23, 2022, which claims the priority to the Chinese Patent Application No. 202111672536.4, filed to the China National Intellectual Property Administration (CNIPA) on Dec. 31, 2021, which is hereby incorporated by reference in its entirety.

### TECHNICAL FIELD

The disclosure relates to a vacuum cleaner, and for example, relates to a noise reduction of the vacuum cleaner.

### BACKGROUND

As a common garbage clearing apparatus, a vacuum cleaner has a common disadvantage of loud working noise. If a user uses the vacuum cleaner to suck garbage for a long time, the long-term working noise of the vacuum cleaner will make the user feel uncomfortable physically and mentally. In the related art, the vacuum cleaner is generally equipped with some noise reduction objects (such as sponges for sound absorption and noise reduction so as to isolate or absorb noise). However, its layout is not desirable, and its noise reduction effect is not ideal.

### SUMMARY

The disclosure provides a vacuum cleaner, which has a relatively superior noise reduction effect on airflow discharged by an impeller.

The disclosure provides a vacuum cleaner, including a motor, an impeller being able to be driven by the motor to rotate so as to generate a suction airflow, an exhaust air duct, an air window wall for ventilation, a first noise reducer which is breathable, and a second noise reducer which is breathable, a tail end of the exhaust air duct is provided with an air duct outlet for air exhaust of the exhaust air duct, the air window wall is located downstream of the air duct outlet, the first noise reducer blocks the exhaust air duct, the second noise reducer is shielded on an inner side of the air window wall, and an airflow discharged by the impeller flows through the exhaust air duct and sequentially passes through the first noise reducer, the second noise reducer, and the air window wall.

In some embodiments, the vacuum cleaner further includes an expansion chamber located downstream of the air duct outlet, the second noise reducer is located inside the expansion chamber, and an airflow output by the air duct outlet is discharged into the expansion chamber and sequentially passes through the second noise reducer and the air window wall so as to be discharged out of the expansion chamber; and the airflow output by the air duct outlet spreads in the expansion chamber, and the air duct outlet constitutes an air inlet of the expansion chamber.

In some embodiments, the air window wall is exposed to an outer side of the vacuum cleaner, the air window wall is in communication with an exterior of the vacuum cleaner and the expansion chamber, the air window wall is provided with a first air window, a second air window and an airtight baffle connected between the first air window and the second air window, the first air window is located on a side, close to the air duct outlet, of the airtight baffle, the second air window is located on a side, away from the air duct outlet, of the airtight baffle, the second noise reducer abuts on an inner side of the first air window, an inner side of the second air window and an inner side of the airtight baffle, the second noise reducer completely shields the first air window and the second air window, and the airflow discharged from the air duct outlet into the expansion chamber is discharged out of the expansion chamber through the first air window and the second air window.

In some embodiments, the vacuum cleaner further includes a handle and an outer shell, the handle is located on an outer side of the outer shell and is connected with the outer shell, the air window wall is arranged on the outer shell, the outer shell is provided with at least one first positioning portion extending downward, the at least one first positioning portion and the air window wall clamp the second noise reducer, and the at least one first positioning portion is located inside the expansion chamber.

In some embodiments, the exhaust air duct is provided with an inner duct, an outer duct connected with the inner duct, and a partition wall, the inner duct is annular around an axis of a rotating shaft of the motor, the impeller is able to be driven by the rotating shaft of the motor to rotate, the outer duct surrounds the inner duct, the outer duct is located downstream of the inner duct, an end of the outer duct constitutes the air duct outlet, an opposite end of the outer duct is in direct communication with the inner duct, and the partition wall is shared by the inner duct and the outer duct so as to separate the inner duct from the outer duct.

In some embodiments, the end, constituting the air duct outlet, of the outer duct constitutes a tail end of the exhaust air duct, and the first noise reducer blocks the end, constituting the air duct outlet, of the outer duct so as to block the exhaust air duct.

In some embodiments, the partition wall is airtight, so as to prevent air in the inner duct from entering the outer duct through the partition wall, and an airflow conveyed by the exhaust air duct is all discharged out of the exhaust air duct from the air duct outlet and all passes through the first noise reducer.

In some embodiments, the partition wall is arc-shaped, and the outer duct is arc-shaped; and the first noise reducer blocks the outer duct.

In some embodiments, the exhaust air duct constitutes a spiral duct, the vacuum cleaner further includes a spiral side wall for forming the spiral duct, the spiral side wall is provided with a circumferential wall for being surrounded to form the inner duct and an outer connection wall connected with the circumferential wall, the circumferential wall is in a non-closed annular shape, the partition wall belongs to the circumferential wall, the partition wall is further configured for forming the outer duct with the outer connection wall, an end of the partition wall is a free end and constitutes an end of the circumferential wall, an opposite end of the circumferential wall is connected with an end of the outer connection wall, and an air outlet of the inner duct is formed between the opposite end of the circumferential wall and the free end of the partition wall, the air outlet of the inner duct constitutes an air inlet of the outer duct, an air outlet of the outer duct is formed between an opposite end of the outer connection wall and an opposite end of the partition wall, and the air outlet of the outer duct constitutes the air duct outlet.

In some embodiments, the partition wall, the outer connection wall and the outer duct are arc-shaped, and the circumferential wall surrounds the axis of the rotating shaft of the motor.

In some embodiments, the vacuum cleaner further includes a lower cover and an exhaust air hood, the exhaust air hood is located on an upper side of the lower cover, the exhaust air duct is formed between the exhaust air hood and the lower cover, and the spiral side wall belongs to the exhaust air hood; and the vacuum cleaner further includes an impeller shell and a third noise reducer, the impeller is located inside the impeller shell, the impeller shell is located between the exhaust air hood and the lower cover, the impeller shell is provided with a plurality of exhaust air outlets located along a circumferential direction thereof, the airflow discharged by the impeller enters the inner duct through the plurality of exhaust air outlets, the third noise reducer is located inside the inner duct, the third noise reducer is sleeved around a periphery of the impeller shell to shield the plurality of exhaust air outlets, the exhaust air hood is provided with a plurality of first extending portions, the plurality of first extending portions are located inside the inner duct and on an upper side of the third noise reducer, and the plurality of first extending portions extend downward and abut against the third noise reducer.

In some embodiments, the inner duct includes an upper annular part and a lower annular part, the upper annular part is formed in the exhaust air hood, the lower annular part surrounds the impeller shell, the third noise reducer is located inside the lower annular part, the lower annular part is in direct communication with the plurality of exhaust air outlets, the airflow discharged by the impeller enters the lower annular part through the plurality of exhaust air outlets and flows upward into the upper annular part, and the plurality of first extending portions are each at least partially accommodated in the upper annular part.

In some embodiments, the vacuum cleaner further includes a dust collecting container, the lower cover covers an upper end of the dust collecting container, the motor is vertically arranged on the upper side of the lower cover, the exhaust air hood is further provided with a middle cylinder wall, the middle cylinder wall surrounds the motor, the middle cylinder wall constitutes an inner circumferential wall of the upper annular part, the plurality of first extending portions are distributed on a periphery of the middle cylinder wall, and the plurality of first extending portions extend downward from a top side of the upper annular part.

In some embodiments, the vacuum cleaner further includes an outer shell, the outer shell is located on the upper side of the lower cover and covers the exhaust air hood, the air window wall is arranged on the outer shell, and a lower end edge of the air window wall is attached to the lower cover; the lower cover is provided with a suction air port, a bottom plate and an annular wall for being surrounded to form the lower annular part, the suction airflow flows through the suction air port, the suction air port penetrates through upper and lower sides of the bottom plate, the bottom plate constitutes a bottom wall of the lower annular part, the impeller shell is located between a lower end of the middle cylinder wall and the bottom plate, and the plurality of first extending portions and the bottom plate clamp the third noise reducer along an up-down direction; and the annular wall extends upward from a circumferential edge of the bottom plate, the circumferential wall couples with the annular wall along the up-down direction, the circumferential wall constitutes an outer circumferential wall of the upper annular part, and the annular wall constitutes an outer circumferential wall of the lower annular part.

In some embodiments, the vacuum cleaner further includes an expansion chamber and a distal wall located downstream of the air duct outlet, the second noise reducer is located inside the expansion chamber, an airflow output by the air duct outlet is discharged into the expansion chamber, and the distal wall, the expansion chamber and the air duct outlet are located on a periphery of the circumferential wall; and the spiral duct surrounds the axis of the rotating shaft of the motor, the air window wall constitutes an outer wall of the expansion chamber relative to an exterior of the vacuum cleaner, a part of the circumferential wall is opposite to the air window wall along a radial direction of the rotating shaft of the motor, the distal wall is opposite to the air duct outlet along a circumferential direction around the inner duct, the distal wall connects the circumferential wall to the air window wall, and the distal wall constitutes a side wall of the expansion chamber and is located on an end, away from the air duct outlet, of the expansion chamber.

In some embodiments, the vacuum cleaner further includes a lower cover and an exhaust air hood, the exhaust air hood is located on an upper side of the lower cover, the exhaust air duct is formed between the exhaust air hood and the lower cover, the distal wall and the spiral side wall belong to the exhaust air hood, the exhaust air hood is further provided with a top plate and a spiral top wall for forming the spiral duct, and the spiral side wall is integrally connected with the spiral top wall; the distal wall belongs to the exhaust air hood, the top plate covers a top side of the expansion chamber, the top plate is integrally connected with a top edge of the distal wall, the first noise reducer is arranged at the air duct outlet, a bottom surface A of an end, adjacent to the air duct outlet, of the spiral top wall is lower than a bottom surface B, adjacent to the air duct outlet, of an end of the top plate, and a blocking wall is connected between the bottom surface A and the bottom surface B; and the blocking wall blocks a side, facing the exhaust air duct, of the first noise reducer to prevent the first noise reducer from escaping inward the spiral duct, and a top of the first noise reducer is higher than the bottom surface A and abuts on the bottom surface B.

In some embodiments, the vacuum cleaner further includes at least one second positioning portion, the at least one second positioning portion integrally extends downward from the top plate, and the at least one second positioning portion blocks a side, facing away from the outer duct, of the first noise reducer to prevent the first noise reducer from leaving the air duct outlet under an impact of airflow in the exhaust air duct; and the spiral top wall is in a spiral rising state, an end, adjacent to the air duct outlet, of the spiral top wall is higher than an opposite end of the spiral top wall, and the opposite end of the spiral top wall is integrally connected with the free end of the partition wall.

In some embodiments, the first noise reducer is arranged at the air duct outlet, and the air duct outlet is toward the air window wall.

In some embodiments, the vacuum cleaner further includes at least one second positioning portion, the first noise reducer is arranged at a predetermined position of the exhaust air duct, and the at least one second positioning portion blocks a side of the first noise reducer to prevent the first noise reducer from leaving the predetermined position under an impact of airflow in the exhaust air duct.

In some embodiments, the predetermined position is the air duct outlet, and the at least one second positioning portion blocks a downstream side of the first noise reducer.

In some embodiments, the at least one second positioning portion is arranged as spaced-apart extension columns.

In some embodiments, a pore density of the first noise reducer is smaller than a pore density of the second noise reducer.

In some embodiments, the vacuum cleaner further includes an air inlet window, an air outlet window, a fourth noise reducer which is breathable and corresponds to the air inlet window, and a fifth noise reducer which is breathable and corresponds to the air outlet window, a heat dissipation airflow for the motor enters the vacuum cleaner through the air inlet window and is discharged out of the vacuum cleaner through the air outlet window, the heat dissipation airflow sequentially passes through the air inlet window, the fourth noise reducer, an interior of the motor, the fifth noise reducer, and the air outlet window, the motor is provided with a heat dissipation fan, and the heat dissipation fan rotates to drive air to flow to form the heat dissipation airflow.

In some embodiments, the vacuum cleaner further includes a dust collecting container, an outer shell, a lower cover, a first buckle, a second buckle, and a handle, the handle is connected with the outer shell, the lower cover covers an upper end of the dust collecting container, the dust collecting container and the lower cover are detachably assembled together by the first buckle and the second buckle, the first buckle is buckled at an edge of a side of the lower cover, the second buckle is buckled at an edge of an opposite side of the lower cover, the outer shell is mounted on an upper side of the lower cover, an air inlet window and an air outlet window are located on left and right sides of the outer shell, and the air window wall is arranged on a front or rear side of the outer shell; and the outer shell is further provided with a first concave portion and a second concave portion, the first concave portion and the second concave portion are located on left and right sides of the outer shell, the first buckle is at least partially accommodated in the first concave portion, the second buckle is at least partially accommodated in the second concave portion, the first concave portion is provided with the air inlet window, the second concave portion is provided with the air outlet window, a fourth noise reducer is located on a side, facing away from the first buckle, of the air inlet window, and a fifth noise reducer is located on a side, facing away from the second buckle, of the air outlet window.

In some embodiments, the outer shell is provided with a first protrusion portion and a second protrusion portion that are located on left and right sides of the outer shell, the first protrusion portion is located on a side, corresponding to the first buckle, of the outer shell, the second protrusion portion is located on a side, corresponding to the second buckle, of the outer shell, the first concave portion is concavely arranged on the first protrusion portion, the second concave portion is concavely arranged on the second protrusion portion, the fourth noise reducer is located inside the first protrusion portion, and the fifth noise reducer is located inside the second protrusion portion.

In some embodiments, the first protrusion portion is provided with a first outer side wall and a second outer side wall that are located on front and rear sides thereof, and a first top side wall located on a top of the first protrusion portion, the fourth noise reducer is located between the first outer side wall and the second outer side wall, the fourth noise reducer is plate-shaped facing the air inlet window, a front side edge of the fourth noise reducer abuts on the first outer side wall, a rear side edge of the fourth noise reducer abuts on the second outer side wall, an upper side edge of the fourth noise reducer abuts on the first top side wall, and a bottom side edge of the fourth noise reducer abuts on the lower cover; and the second protrusion portion is provided with a third outer side wall and a fourth outer side wall that are located on front and rear sides thereof, and a second top side wall located on a top of the second protrusion portion, the fifth noise reducer is located between the third outer side wall and the fourth outer side wall, the fifth noise reducer is plate-shaped facing the air outlet window, a front side edge of the fifth noise reducer abuts on the third outer side wall, a rear side edge of the fifth noise reducer abuts on the fourth outer side wall, an upper side edge of the fifth noise reducer abuts on the second top side wall, a bottom side edge of the fifth noise reducer abuts on the lower cover, and a lower end of the first outer side wall, a lower end of the second outer side wall, a lower end of the third outer side wall, a lower end of the fourth outer side wall, a lower end of the air inlet window and a lower end of the air outlet window are attached to the lower cover separately.

In some embodiments, the first protrusion portion is further provided with a first top side wall located on a top of the first protrusion portion, the second protrusion portion is further provided with a second top side wall located on a top of the second protrusion portion, the fourth noise reducer is located on a lower side of the first top side wall, the fifth noise reducer is located on a lower side of the second top side wall, the outer shell is provided with at least one third positioning portion for fixing the fourth noise reducer, and at least one fourth positioning portion for fixing the fifth noise reducer, the at least one third positioning portion is located inside the first protrusion portion and integrally extends downward from the first top side wall, and the at least one fourth positioning portion is located inside the second protrusion portion and integrally extends downward from the second top side wall.

In some embodiments, the fourth noise reducer is plate-shaped and is shielded on an inner side of the air inlet window, and the fifth noise reducer is plate-shaped and is shielded on an inner side of the air outlet window; and the outer shell is provided with at least one third positioning portion for fixing the fourth noise reducer, and at least one fourth positioning portion for fixing the fifth noise reducer, the at least one third positioning portion and the air inlet window clamp the fourth noise reducer, and the at least one fourth positioning portion and the air outlet window clamp the fifth noise reducer.

In some embodiments, the air inlet window is provided with a plurality of first grid plates in parallel, the plurality of first grid plates are located on the side, facing away from the first buckle, of the air inlet window, the air outlet window is provided with a plurality of second grid plates in parallel, the plurality of second grid plates are located on the side, facing away from the second buckle, of the air outlet window, the at least one third positioning portion and the plurality of first grid plates clamp the fourth noise reducer, and the at least one fourth positioning portion and the plurality of second grid plates clamp the fifth noise reducer.

In some embodiments, the vacuum cleaner further includes a heat dissipation duct, the motor is provided with a heat dissipation air inlet and a heat dissipation air outlet, the heat dissipation airflow enters the motor from the heat dissipation air inlet and is discharged out of the motor from the heat dissipation air outlet so as to flow into the heat dissipation duct, an end of the heat dissipation duct is provided with an air outlet, the air outlet window is located downstream of the air outlet of the heat dissipation duct, and the heat dissipation duct is in fluid communication between the heat dissipation air outlet of the motor and an interior of the second protrusion portion.

In some embodiments, the air outlet of the heat dissipation duct and the air outlet window are located on left and right sides of the second protrusion portion, the air outlet of the heat dissipation duct is toward the air outlet window, and the air outlet of the heat dissipation duct is in direct communication with the interior of the second protrusion portion.

In some embodiments, the vacuum cleaner further includes a heat dissipation air hood for forming the heat dissipation duct and a sealing washer, the air outlet of the heat dissipation duct is located on an end, close to the air outlet window, of the heat dissipation air hood, the heat dissipation air hood is provided with a sleeve ring portion, and the sealing washer is sleeved on an upper end of the motor and is sealed between the sleeve ring portion and a circumferential edge of the upper end of the motor, so as to isolate the heat dissipation air inlet of the motor from the heat dissipation duct.

In some embodiments, the heat dissipation air outlet of the motor is located on a bottom side thereof, the heat dissipation duct includes an annular part surrounding the motor and a leading-out part located downstream of the annular part, and with respect to the air outlet window, the air outlet of the heat dissipation duct is located on an end, close to the air outlet window, of the leading-out part; and with respect to the annular part, the air outlet of the heat dissipation duct is located on an end, away from the annular part, of the leading-out part.

In some embodiments, the first concave portion is formed with a first groove, the second concave portion is formed with a second groove, the first groove is located on a side, facing the first buckle, of the air inlet window; the second groove is located on a side, facing the second buckle, of the air outlet window;

the first buckle is at least partially accommodated in the first groove, the second buckle is at least partially accommodated in the second groove, the air inlet window is in direct communication with the first groove and an interior of the first protrusion portion, and the air outlet window is in direct communication with the second groove and the interior of the second protrusion portion; and the heat dissipation airflow enters the first protrusion portion through the first groove and the air inlet window in sequence and passes through the fourth noise reducer inside the first protrusion portion, the heat dissipation airflow downwardly passes through the interior of the motor from the heat dissipation air inlet and flows out of the motor from the heat dissipation air outlet on the bottom side of the motor, the heat dissipation airflow, after flowing out of the heat dissipation air outlet, enters the annular part of the heat dissipation duct; the heat dissipation airflow flows upward to an upper part of the annular part and is converged into the leading-out part of the heat dissipation duct, and is discharged out of the heat dissipation duct from the air outlet of the heat dissipation duct so as to enter the second protrusion portion, and the heat dissipation airflow passes through the fifth noise reducer inside the second protrusion portion and is discharged through the air outlet window.

In some embodiments, the first concave portion is formed with a first groove, the second concave portion is formed with a second groove, the first groove is located on a side, facing the first buckle, of the air inlet window, the second groove is located on a side, facing the second buckle, of the air outlet window, the first buckle is at least partially accommodated in the first groove, the second buckle is at least partially accommodated in the second groove, the air inlet window is in direct communication with the first groove and an interior of the first protrusion portion, and the air outlet window is in direct communication with the second groove and the interior of the second protrusion portion; and the heat dissipation airflow enters the first protrusion portion through the first groove and the air inlet window in sequence and passes through the fourth noise reducer inside the first protrusion portion.

According to the disclosure, when an airflow discharged by the impeller flows along an exhaust air duct, the airflow flowing in the duct is subjected to noise reduction by passing through a first noise reducer blocking the exhaust air duct, and is subjected to further noise reduction by passing through a second noise reducer covered with an inner side of an air window wall before the airflow is discharged out of an air window, such that a noise reduction effect is relatively superior.

### BRIEF DESCRIPTION OF THE DRAWINGS

FIG. 1 is a three-dimensional diagram of a vacuum cleaner of the disclosure;

FIG. 2 is a vertical sectional view (not showing a dust collecting container, wheels, etc.) of a vacuum cleaner of the disclosure;

FIG. 3 is a horizontal sectional view (top view, not showing a dust collecting container, wheels, and an accessory bag assembly) of a vacuum cleaner of the disclosure;

FIG. 4 is another horizontal sectional view (bottom view) of a vacuum cleaner of the disclosure;

FIG. 5 is an exploded view of a part of a vacuum cleaner of the disclosure;

FIG. 6 is an exploded view of another part of a vacuum cleaner of the disclosure;

FIG. 7 is a three-dimensional diagram of a lower cover, an exhaust air hood, etc., in a combined state, of a vacuum cleaner of the disclosure;

FIG. 8 is a three-dimensional diagram of an exhaust air hood of a vacuum cleaner of the disclosure;

FIG. 9 is another vertical sectional view (not showing a dust collecting container, wheels, etc.) of a vacuum cleaner of the disclosure;

FIG. 10 is a view of a dust collecting container, in a separated state with a first buckle and a second buckle, of a vacuum cleaner of the disclosure; and

FIG. 11 is a three-dimensional diagram of a motor of a vacuum cleaner of the disclosure.

### DETAILED DESCRIPTION OF THE EMBODIMENTS

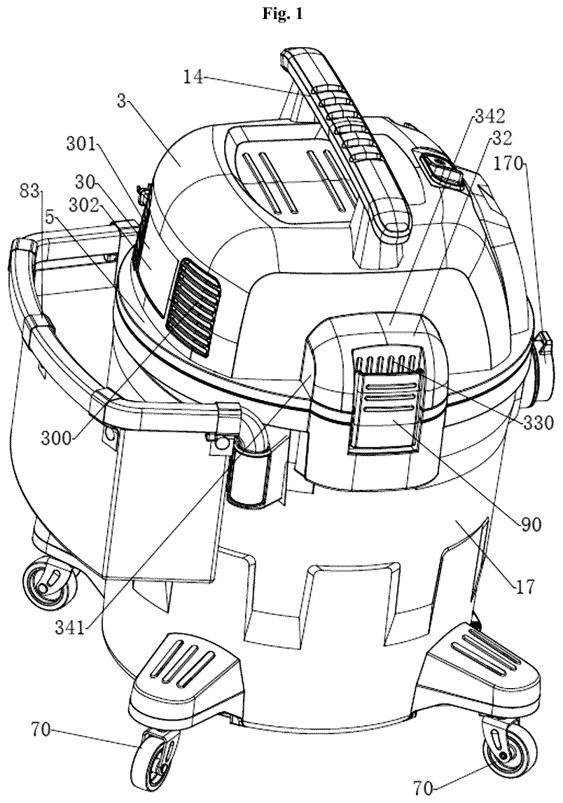

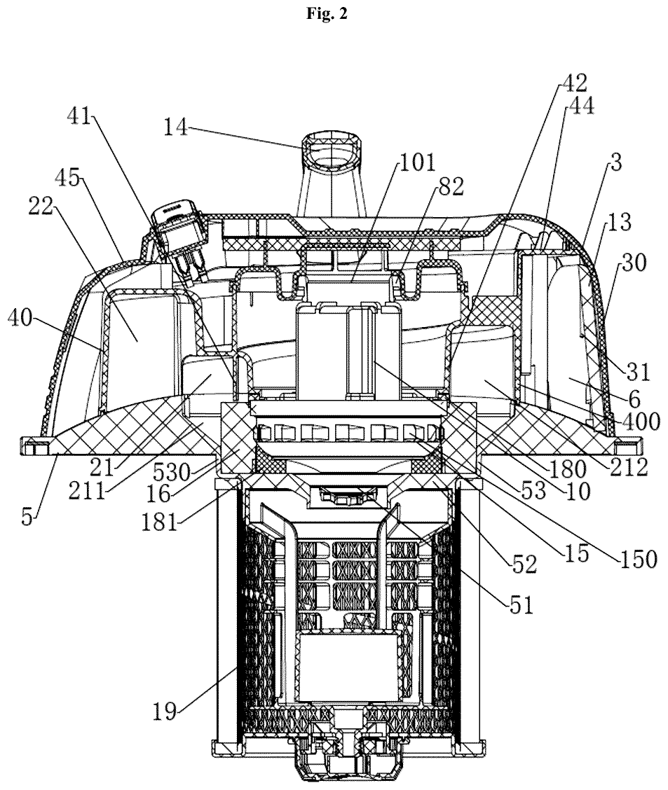

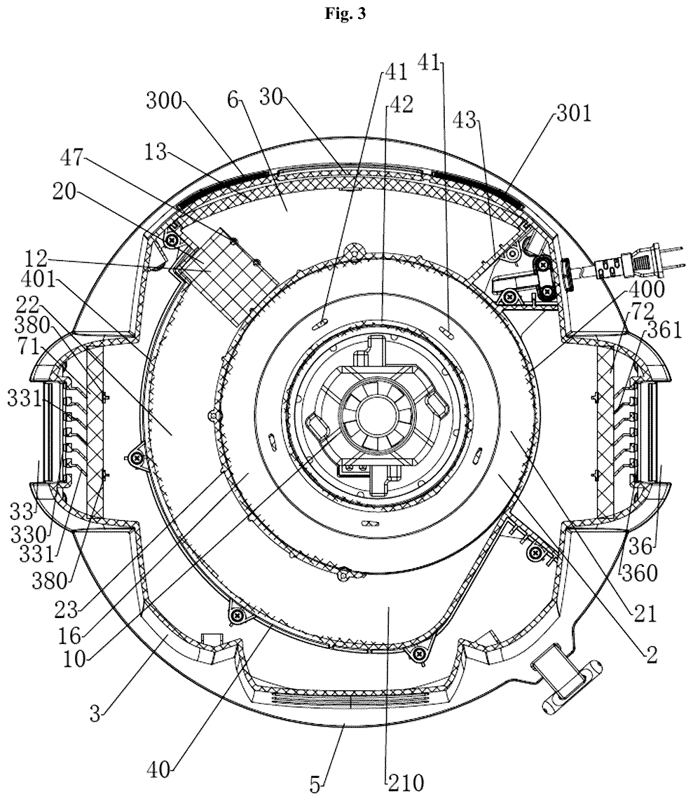

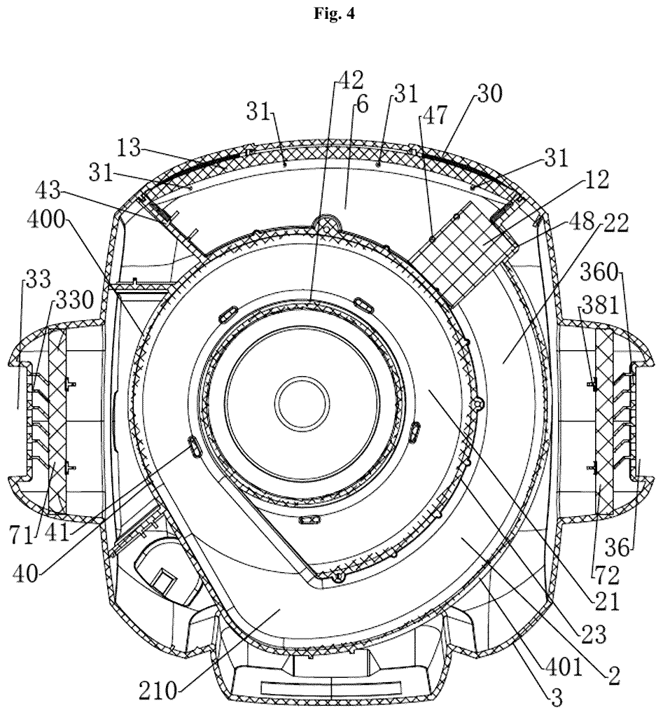

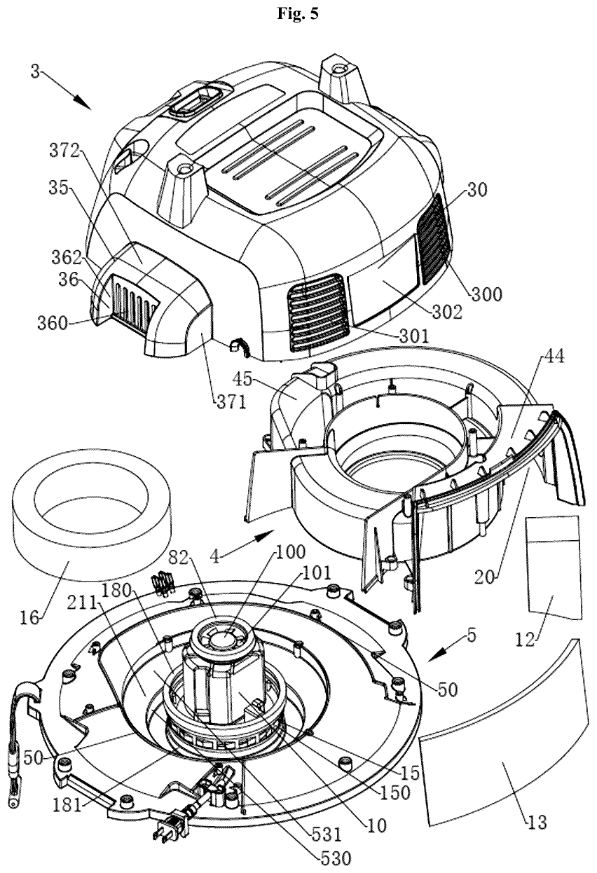

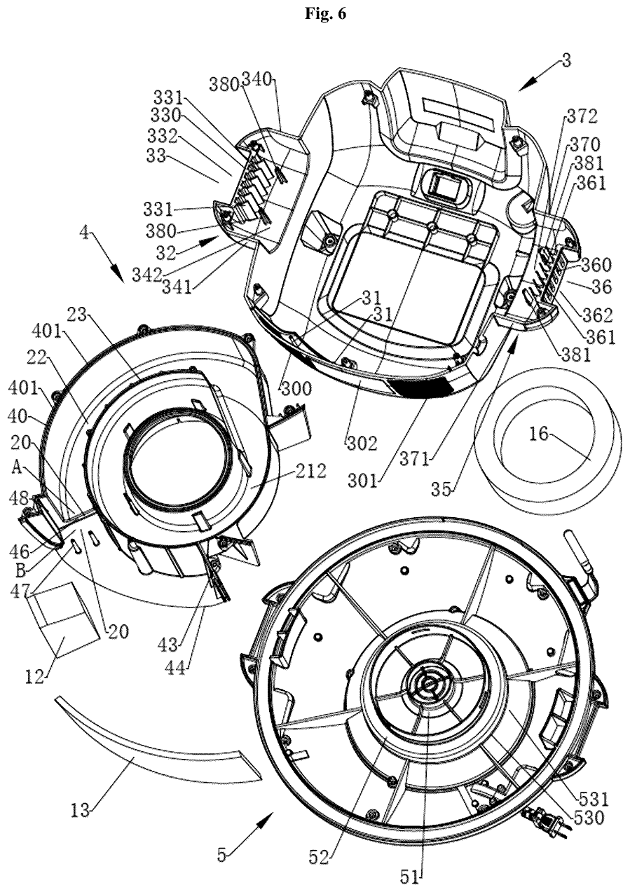

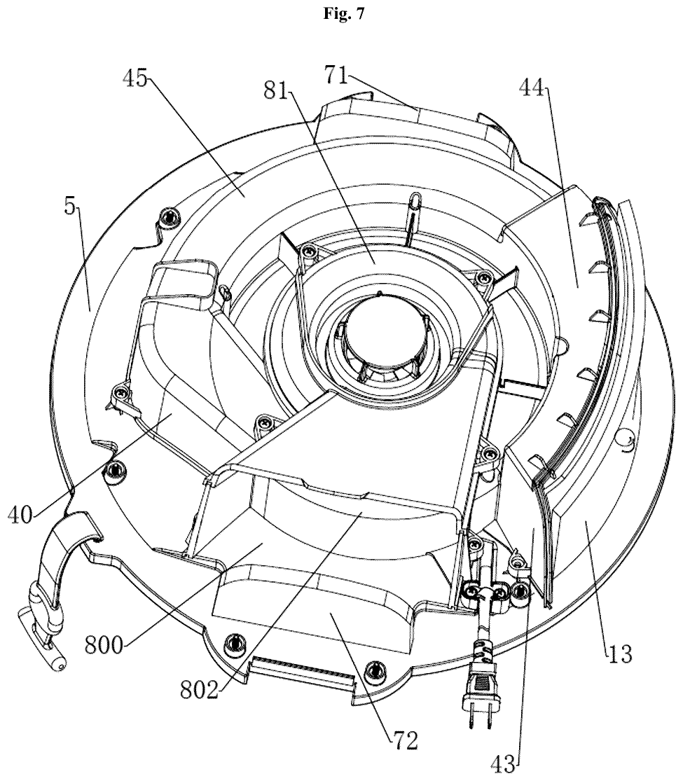

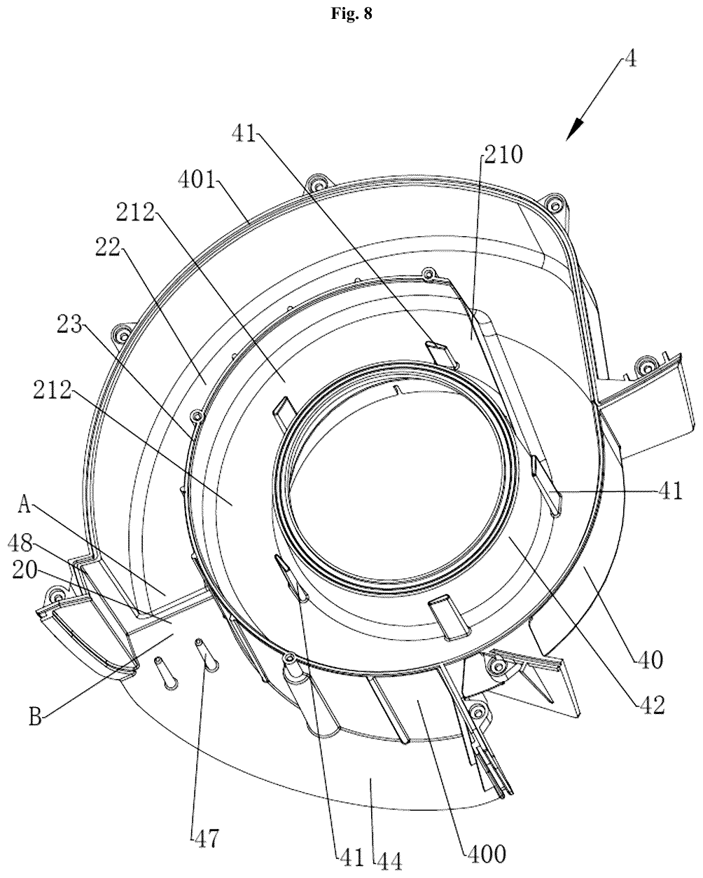

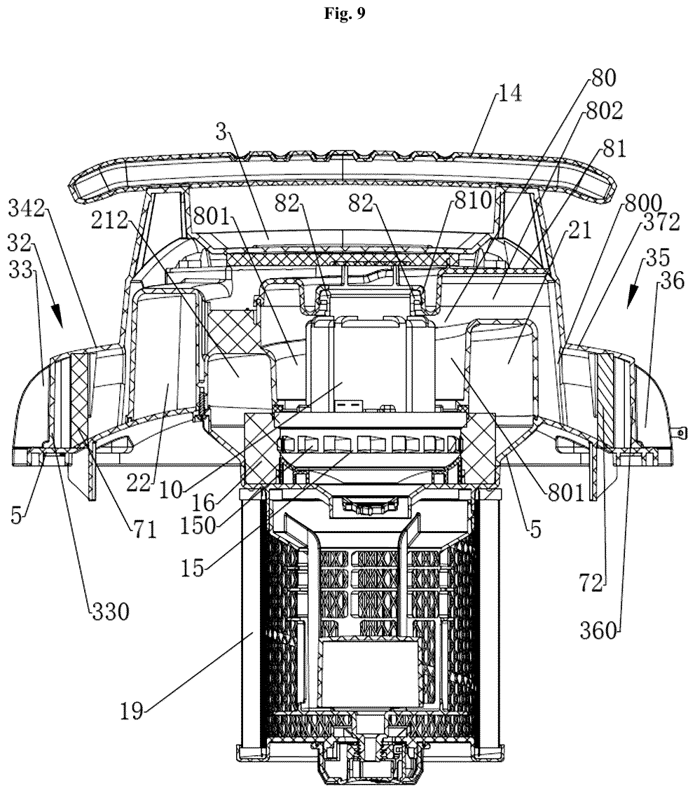

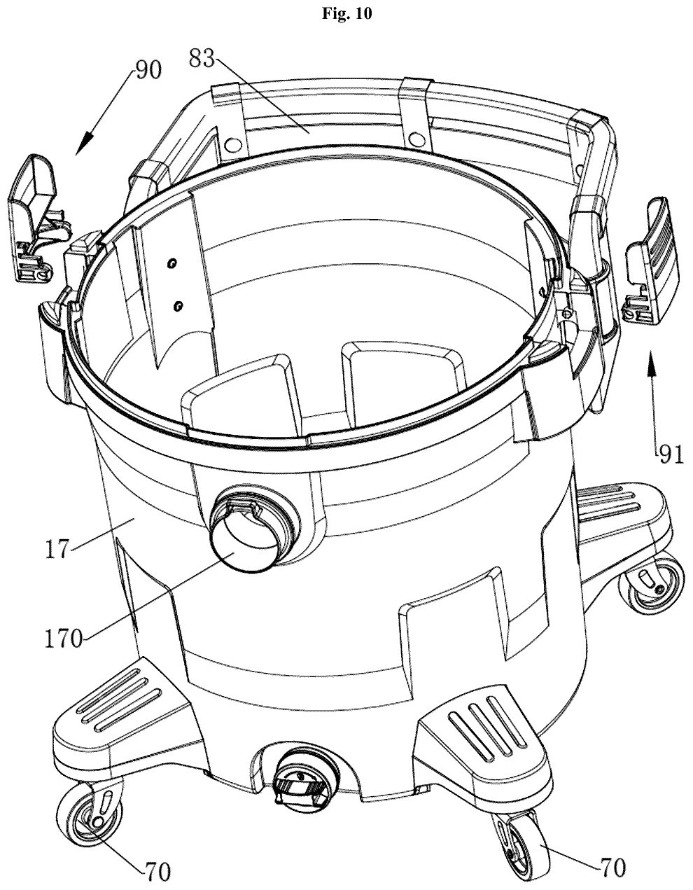

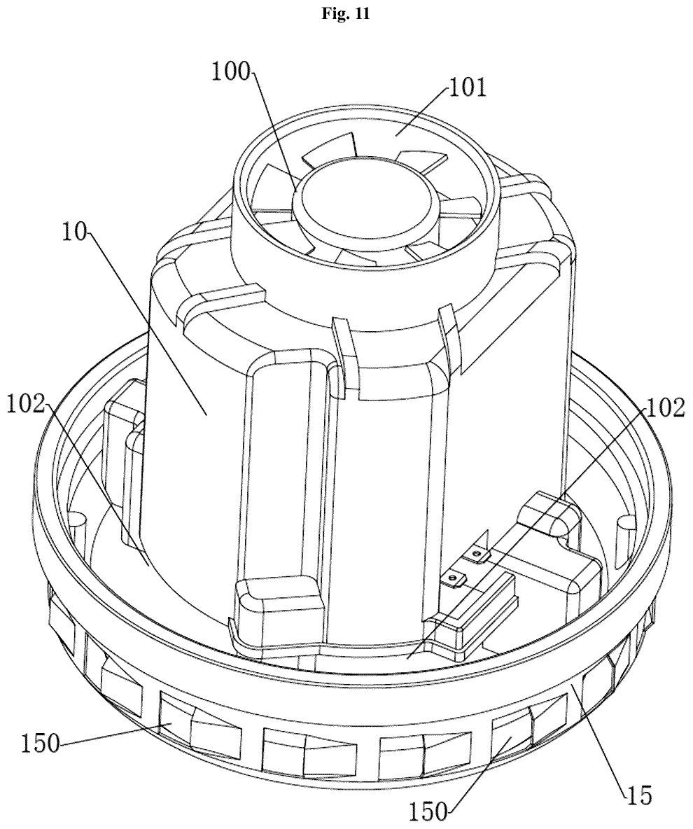

Refer to FIGS. 1-11, a vacuum cleaner is disclosed. The vacuum cleaner is provided with a motor 10, and an impeller being able to be driven by the motor 10 to rotate so as to generate a suction airflow. The impeller generates the suction airflow, such that the vacuum cleaner is able to suck garbage. The vacuum cleaner further includes an exhaust air duct 2, an air window wall 30 for ventilation, a first noise reducer 12 which is breathable, and a second noise reducer 13 which is breathable. A tail end of the exhaust air duct 2 is provided with an air duct outlet 20 for air exhaust of the exhaust air duct 2. The air window wall 30 is located downstream of the air duct outlet 20. The first noise reducer 12 blocks the exhaust air duct 2. The second noise reducer 13 is shielded on an inner side of the air window wall 30, and an airflow discharged by the impeller flows through the exhaust air duct 2 and sequentially passes through the first noise reducer 12, the second noise reducer 13, and the air window wall 30. Through the above design, when the airflow discharged by the impeller flows along the exhaust air duct 2, the airflow is subjected to preliminary noise reduction by passing through the first noise reducer 12 blocking the exhaust air duct 2, and is subjected to further noise reduction by passing through the second noise reducer 13 shielded on the inner side of the air window wall 30, such that a noise reduction effect is relatively superior.

The vacuum cleaner further includes an expansion chamber 6 located downstream of the air duct outlet 20, the second noise reducer 13 is located inside the expansion chamber 6, an airflow output by the air duct outlet 20 is discharged into the expansion chamber 6 and sequentially passes through the second noise reducer 13 and the air window wall 30 so as to be discharged out of the expansion chamber 6; the air duct outlet 20 constitutes an air inlet of the expansion chamber 6, the airflow output by the air duct outlet 20 spreads in the expansion chamber 6. That is, the expansion chamber 6 is spatially expanded or enlarged in size relative to the air duct outlet 20, such that air from the exhaust air duct 2 is able to widely spread in the expansion chamber 6, which reduces noise of the airflow. The air window wall 30 constitutes an outer wall of the expansion chamber 6 relative to an exterior of the vacuum cleaner, and air in the expansion chamber 6 passes through the air window wall 30 so as to flow out of the vacuum cleaner.

The air window wall 30 is exposed to an outer side of the vacuum cleaner, the air window wall 30 is in communication with an exterior of the vacuum cleaner and the expansion chamber 6, the air window wall 30 is provided with a first air window 300, a second air window 301 and an airtight baffle 302 connected between the first air window 300 and the second air window 301. The first air window 300 is located on a side, close to the air duct outlet 20, of the airtight baffle 302, the second air window 301 is located on a side, away from the air duct outlet 20, of the airtight baffle 302, the second noise reducer 13 abuts on an inner side of the first air window 300, an inner side of the second air window 301 and an inner side of the airtight baffle 302, the second noise reducer 13 completely shields the first air window 300 and the second air window 301, the airflow discharged from the air duct outlet 20 into the expansion chamber 6 is discharged out of the expansion chamber 6 through the first air window 300 and the second air window 301. A layout of the first air window 300, the airtight baffle 302 and the second air window 301 is conducive to matching with the expansion chamber 6 having a larger size, so as to facilitate spreading of air from the air outlet in the expansion chamber 6 and reduction of noise generated. Since the second noise reducer further abuts on the airtight baffle 302, and an airflow flowing to the airtight baffle 302 further has to pass through the second noise reducer, such that direct impact of the airflow on the airtight baffle 302 is avoided or reduced, and the noise generated is reduced. The arrangement of the airtight baffle 302 enhances strength of the entire air window wall 30, and avoids a problem of insufficient strength caused by providing an air window on the entire air window wall 30. In addition, an outer surface of the airtight baffle 302 is able to be configured for labeling.

The vacuum cleaner further includes a handle 14 and an outer shell 3, the handle 14 is located on an outer side of the outer shell 3 and is connected to the outer shell 3, the air window wall 30 is arranged on the outer shell 3, the outer shell 3 is provided with at least one first positioning portion 31 extending downward, the at least one first positioning portion 31 and the air window wall 30 clamp the second noise reducer 13, the at least one first positioning portion 31 is located in the expansion chamber 6; the at least one first positioning portion 31 is arranged as spaced-apart extension columns, to reduce blocking to an airflow passing through the second noise reducer 13.

The exhaust air duct 2 is provided with an inner duct 21, an outer duct 22 connected with the inner duct 21, and a partition wall 23, the inner duct 21 is annular around an axis of a rotating shaft of the motor 10, the outer duct 22 surrounds the inner duct 21, the outer duct 22 is located downstream of the inner duct 21, an end of the outer duct 22 constitutes the air duct outlet 20, and an opposite end of the outer duct 22 is in direct communication with the inner duct 21, the partition wall 23 is shared by the inner duct 21 and the outer duct 22 so as to separate the inner duct 21 from the outer duct 22; Through the above design, the layout structure is practical, and is conducive to extension of a length of the exhaust air duct 2 and further reduction of the noise. The first noise reducer 12 blocks the outer duct 22. The impeller is fixed to the rotating shaft of the motor 10. The impeller is driven by the rotating shaft of the motor 10 to rotate.

The end, constituting the air duct outlet 20, of the outer duct 22 constitutes a tail end of the exhaust air duct 2, the first noise reducer 12 blocks the end, constituting the air duct outlet 20, of the outer duct 22 so as to block the exhaust air duct 2. In this way, the exhaust air duct 2 is able to be simply and conveniently blocked, which is further conducive to improvement in a noise reduction effect.

The partition wall 23 is airtight so as to prevent airflow in the inner duct 21 from entering the outer duct 22 through the partition wall 23, and an airflow conveyed by the exhaust air duct 2 is all discharged out of the exhaust air duct 2 from the air duct outlet 20 and all passes through the first noise reducer 12, so as to be conducive to more complete noise reduction of the air without omission, and further avoid air straggling. The partition wall 23 is arc-shaped, the outer duct 22 is arc-shaped.

The exhaust air duct 2 constitutes a spiral duct, that is, a duct in a spiral shape, the vacuum cleaner further includes a spiral side wall 40 for forming the spiral duct, the spiral side wall 40 is provided with a circumferential wall 400 for being surrounded to form the inner duct 21 and an outer connection wall 401 connected to the circumferential wall 400, the circumferential wall 400 is in a non-closed annular shape, The partition wall 23 belongs to the circumferential wall 400, the partition wall 23 is further configured for forming the outer duct 22 with the outer connection wall 401, an end of the partition wall 23 is a free end and constitutes an end of the circumferential wall 400, an opposite end of the circumferential wall 400 is connected to an end of the outer connection wall 401, and an air outlet 210 of the inner duct 21 is formed between the opposite end of the circumferential wall 400 and the free end of the partition wall 23, the air outlet 210 of the inner duct 21 constitutes an air inlet of the outer duct 22, an air outlet of the outer duct 22 is formed between an opposite end of the outer connection wall 401 and an opposite end of the partition wall 23, the air outlet of the outer duct 22 constitutes the air duct outlet 20. The layout structure is novel, and is conducive to extension of a length of the exhaust air duct 2. The spiral duct is further conducive to orderly discharge of the air, such that noise is reduced, the outer connection wall 401 is arc-shaped, and the circumferential wall 400 surrounds the axis of the rotating shaft of the motor 10.

The vacuum cleaner further includes an exhaust air hood 4 and a lower cover 5, the exhaust air hood 4 is located on an upper side of the lower cover 5, the exhaust air duct 2 is formed between the exhaust air hood 4 and the lower cover 5, the spiral side wall 40 belongs to the exhaust air hood 4. The lower cover 5 is provided with a spiral band 50 corresponding to the spiral side wall 40, that is, the spiral band 50 extends in a spiral shape; the spiral band 50 is coupled with the spiral side wall 40, in order to facilitate coupling between the spiral band 50 and the spiral side wall 40, the spiral band 50 is able to form a groove allowing a lower end edge of the spiral side wall 40 to be embedded into and/or a rib embedded into the lower end edge of the spiral side wall 40, such that stable coupling and sealing between the spiral band 50 and the spiral side wall 40 are promoted.

The impeller is located below the motor 10, the vacuum cleaner further includes an impeller shell 15 and a third noise reducer 16, the impeller is located inside the impeller shell 15, the impeller shell 15 is located between the exhaust air hood 4 and the lower cover 5, the impeller shell 15 is provided with a plurality of exhaust air outlets 150 located along a circumferential direction of the impeller shell 15, the airflow discharged by the impeller enters the inner duct 21 through the plurality of exhaust air outlets 150, the third noise reducer 16 is located inside the inner duct 21, the third noise reducer 16 is sleeved around a periphery of the impeller shell 15 to shield the plurality of exhaust air outlets 150, the exhaust air hood 4 is provided with a plurality of first extending portions 41, the plurality of first extending portions 41 are located inside the inner duct 21 and on an upper side of the third noise reducer 16. The plurality of first extending portions 41 extend downward and abut against the third noise reducer 16, in this way, the third noise reducer 16 is positioned, and the third noise reducer 16 is prevented from escaping upward. The third noise reducer 16 is clamped between the plurality of first extending portions 41 and the lower cover 5.

The inner duct 21 includes a lower annular part 211 and an upper annular part 212, the upper annular part 212 is formed in the exhaust air hood 4, the lower annular part 211 corresponds to the lower cover 5, the lower annular part 211 surrounds the impeller shell 15, the upper annular part 212 surrounds the motor 10, the third noise reducer 16 is located inside the lower annular part 211, the lower annular part 211 is in direct communication with the plurality of exhaust air outlets 150, the airflow discharged by the impeller enters the lower annular part 211 through the plurality of exhaust air outlets 150 and flows upward into the upper annular part 212, the plurality of first extending portions 41 extend downward from a top side of the upper annular part 212, the plurality of first extending portions 41 are each at least partially accommodated in the upper annular part 212.

The vacuum cleaner further includes a dust collecting container 17, the lower cover 5 covers an upper end of the dust collecting container 17, the motor 10 is vertically arranged on the upper side of the lower cover 5, the exhaust air hood 4 is further provided with a middle cylinder wall 42, the middle cylinder wall 42 surrounds the motor 10, the middle cylinder wall 42 constitutes an inner circumferential wall of the upper annular part 212. The plurality of first extending portions 41 are distributed on a periphery of the middle cylinder wall 42. The spiral duct is in a spiral rising state, that is, an upper edge of the spiral duct gradually rises along a spiral direction; the impeller shell 15 is fixedly arranged on a lower side of the motor 10; the outer shell 3 is located on the upper side of the lower cover 5 and covers the exhaust air hood 4, a lower end edge of the air window wall 30 is attached to the lower cover 5; the lower cover 5 is provided with a suction air port 51, a bottom plate 52, and an annular wall 53 for being surrounded to form the lower annular part 211, the suction airflow flows through the suction air port 51, the suction air port 51 penetrates through upper and lower sides of the bottom plate 52, the bottom plate 52 constitutes a bottom wall of the lower annular part 211, the impeller shell 15 is located between a lower end of the middle cylinder wall 42 and the bottom plate 52, the plurality of first extending portions 41 and the bottom plate 52 clamp the third noise reducer 16 along an up-down direction; the annular wall 53 extends upward from a circumferential edge of the bottom plate 52, the annular wall 53 constitutes an outer circumferential wall of the lower annular part 211, the circumferential wall 400 constitutes an outer circumferential wall of the upper annular part 212, the circumferential wall 400 couples with the annular wall 53 along the up-down direction. An upper end edge of the annular wall 53 constitutes a part of the spiral band 50, A first flexible washer 180 is arranged between the impeller shell 15 and the lower end of the middle cylinder wall 42, the lower end of the middle cylinder wall 42 abuts against the first flexible washer 180, and the first flexible washer 180 achieves shock absorption and sealing between the impeller shell 15 and the middle cylinder wall 42; a second flexible washer 181 is arranged between the impeller shell 15 and the bottom plate 52, and the second flexible washer 181 achieves shock absorption and sealing between the impeller shell 15 and the bottom plate 52. In the embodiment, five first extending portions 41 are uniformly distributed on a periphery of the middle cylinder wall 42. The annular wall 53 includes a cylindrical wall 530 on a lower side and a conical wall 531 on an upper side. The conical wall 531 is integrally connected to the cylindrical wall 530 along the up-down direction.

The entire expansion chamber 6 is arc-shaped, the expansion chamber 6 is surrounded together to form by a part of the lower cover 5, a part of the exhaust air hood 4, and the air window wall 30. In the embodiment, the second noise reducer 13 is sheet-shaped, during assembling, the second noise reducer 13 is clamped and positioned between the at least one first positioning portion 31 and the air window wall 30, such that the second noise reducer 13 is fixed to the outer shell 3, then the outer shell 3 covers the exhaust air hood 4 and is locked to the lower cover 5, and the outer shell 3 is locked to the lower cover 5 by screws.

The vacuum cleaner further includes a distal wall 43, the distal wall 43, the expansion chamber 6 and the air duct outlet 20 are located on a periphery of the circumferential wall 400; the spiral duct surrounds the axis of the rotating shaft of the motor 10; a part of the circumferential wall 400 is opposite to the air window wall 30 along a radial direction of the rotating shaft of the motor 10, the distal wall 43 is opposite to the air duct outlet 20 along a circumferential direction around the inner duct 21, the distal wall 43 connects the circumferential wall 400 to the air window wall 30, the distal wall 43 constitutes a side wall of the expansion chamber 6 and is located on an end, away from the air duct outlet 20, of the expansion chamber 6. The distal wall 43 belongs to the exhaust air hood 4, the exhaust air hood 4 is further provided with a top plate 44 and a spiral top wall 45 for forming the spiral duct, the spiral side wall 40 is integrally connected to the spiral top wall 45; the top plate 44 shields a top side of the expansion chamber 6, the top plate 44 is integrally connected to a top edge of the distal wall 43, the first noise reducer 12 is arranged at the air duct outlet 20, a bottom surface A of an end, adjacent to the air duct outlet 20, of the spiral top wall 45 is lower than a bottom surface B of an end, adjacent to the air duct outlet 20, of the top plate 44, a blocking wall 46 is connected between the bottom surface A and the bottom surface B; the blocking wall 46 blocks a side, facing the exhaust air duct 2, of the first noise reducer 12 so as to prevent the first noise reducer 12 from escaping inward the spiral duct, a top of the first noise reducer 12 is higher than the bottom surface A and abuts on the bottom surface B. The plurality of first extending portions 41 extend downward from the top plate 44.

The vacuum cleaner further includes at least one second positioning portion 47, the second positioning portion 47 integrally extends downward from the top plate 44, the at least one second positioning portion 47 blocks a side, facing away from the outer duct 22, of the first noise reducer 12 so as to prevent the first noise reducer 12 from leaving the air duct outlet 20 under the impact of airflow in the exhaust air duct 2; the spiral top wall 45 is in a spiral rising state, an end, adjacent to the air duct outlet 20, of the spiral top wall 45 is higher than an opposite end of the spiral top wall 45, the opposite end of the spiral top wall 45 is integrally connected to the free end of the partition wall 23. The bottom surface A, the blocking wall 46 and the bottom surface B are connected to form a step shape, the second positioning portion 47 is arranged as extension column integrally extending downward from the top plate 44. The opposite end of the outer connection wall 401 is provided with a corner portion 48, the first noise reducer 12 is partially accommodated in the corner portion 48, the first noise reducer 12 is limited among the at least one second positioning portion 47, the corner portion 48 and the blocking wall 46. The first noise reducer 12 is block-shaped, during assembling, the first noise reducer 12 is clamped and positioned among the at least one second positioning portion 47, the corner portion 48 and the blocking wall 46, then the exhaust air hood 4 is mounted on the lower cover 5, and the exhaust air hood 4 is locked to the lower cover 5 by screws.

The air duct outlet 20 is toward the air window wall 30. The first noise reducer 12 is arranged at a predetermined position of the exhaust air duct 2, the at least one second positioning portion 47 blocks a side of the first noise reducer 12 to prevent the first noise reducer 12 from leaving the predetermined position under the impact of airflow in the exhaust air duct 2. In the embodiment, the predetermined position is the air duct outlet 20, that is, the first noise reducer 12 is arranged at the air duct outlet 20, and the at least one second positioning portion 47 blocks a downstream side of the first noise reducer 12. The airflow conveyed by the exhaust air duct flows from an upstream side of the first noise reducer 12 to the downstream side of the first noise reducer 12, so as to pass through the first noise reducer 12.

The vacuum cleaner further includes a plurality of wheels 7 allowing the vacuum cleaner to move. A capacity of the dust collecting container 17 is 0.5 gal-30 gal, and for instance, 1 gal-20 gal; rated power of the motor 10 is 100 w-3000 w, and for instance, 200 w-1900 w. The first noise reducer 12 and the second noise reducer 13 are able to be made of silencing cotton, such as polyurethane sponge, polyether sponge, glass wool, felt, and rock wool. In order to balance noise reduction performance and air outlet performance of the vacuum cleaner, an air permeability of the first noise reducer 12 is greater than that of the second noise reducer 13. In an embodiment, a pores per linear inch (PPI) (that is, a pore density) of the first noise reducer 12 is smaller than that of the second noise reducer 13, for instance, a PPI of the first noise reducer 12 is 20, and a PPI of the second noise reducer 13 is 25. A filter 19 is located in the dust collecting container 17 and mounted on a bottom side of the lower cover 5. The dust collecting container 17 is provided with a dirt suction port 170, during garbage suction, garbage enters the dust collecting container 17 from the dirt suction air port 170 along with the suction airflow, and the suction airflow flows through the filter 19, such that the garbage is filtered by the filter 19 and left in the dust collecting container 17, further, the suction airflow flows to the impeller through the suction air port 51 and is discharged by the impeller so as to form an exhaust air, and the exhaust air is discharged into the lower annular part 211 through the plurality of exhaust air outlets 150 and passes through the third noise reducer 16, further, the exhaust air flows into the upper annular part 212 and enters the outer duct 22 from the air outlet of the inner duct 21, the exhaust air flows along the outer duct 22 to the air outlet of the outer duct 22, and passes through the first noise reducer 12, so as to enter the expansion chamber 6, then passes through the first noise reducer 12, and finally is discharged out of the vacuum cleaner from the first air window 300 and the second air window 301.

The vacuum cleaner further includes an air inlet window 330, an air outlet window 360, a fourth noise reducer 71 which is breathable and corresponds to the air inlet window 330, and a fifth noise reducer 72 which is breathable and corresponds to the air outlet window 360, an heat dissipation airflow for the motor 10 enters the vacuum cleaner through the air inlet window 330 and is discharged out of the vacuum cleaner through the air outlet window 360, the heat dissipation airflow sequentially passes through the air inlet window 330, the fourth noise reducer 71, an interior of the motor 10, the fifth noise reducer 72, and the air outlet window 360, the motor 10 is provided with a heat dissipation fan 100, the heat dissipation fan 100 rotates to drive air to flow to form the heat dissipation airflow, the fourth noise reducer 71 and the third noise reducer 16 are able to be made of silencing cotton.

The vacuum cleaner further includes a first buckle 90 and a second buckle 91. The handle 14 is connected to the outer shell 3, the lower cover 5 covers an upper end of the dust collecting container 17, the dust collecting container 17 and the lower cover 5 are detachably assembled together by the first buckle 90 and the second buckle 91, the first buckle 90 is buckled at an edge of one side of the lower cover 5, the second buckle 91 is buckled at an edge of an opposite side of the lower cover 5, the outer shell 3 is mounted on an upper side of the lower cover 5, the air inlet window 330 and the air outlet window 360 are located on left and right sides of the outer shell 3, the air window wall 30 is arranged on a front or rear side of the outer shell 3 (in the embodiment, the air window wall 30 is arranged on the rear side of the outer shell 3); the outer shell 3 further includes a first concave portion 33 and a second concave portion 36, the first concave portion 33 and the second concave portion 36 are located on the left and right sides of the outer shell 3, the first buckle 90 is at least partially accommodated in the first concave portion 33, the second buckle 91 is at least partially accommodated in the second concave portion 36, the first concave portion 33 is provided with the air inlet window 330, the second concave portion 36 is provided with the air outlet window 360, the fourth noise reducer 71 is located on a side, facing away from the first buckle 90, of the air inlet window 330, the fifth noise reducer 72 is located on a side, facing away from the second buckle 91, of the air outlet window 360. Through the layout, the first concave portion 33 and the second concave portion 36 on opposite sides of the outer shell 3 and at least partially accommodate the first buckle 90 and the second buckle 91 are effectively utilized for arranging the air inlet window 330 and the air outlet window 360 that are configured for heat dissipation of the motor 10, such that the first concave portion 33 and the second concave portion 36 constitute an air inlet-outlet relation, and functions of the first concave portion 33 and the second concave portion 36 as a whole are expanded; moreover, the air inlet window 330 and the air outlet window 360 are located on left and right sides of the outer shell 3 so as to be fully separated, and the heat dissipation airflow of the motor 10 enters through the air inlet window 330 located on a side of the outer shell 3 and exits through the air outlet window 360 located on the opposite side of the outer shell 3, such that relatively cold air entering from the air inlet window 330 and relatively hot air exiting from the air outlet window 360 are fully separated, and heat dissipation efficiency of the motor 10 is improved. In the embodiment, the first buckle 90 and the second buckle 91 have basically the same structure and are able to be used interchangeably. The first buckle 90 is pivotally connected to an upper left side of the dust collecting container 17, and the second buckle 91 is pivotally connected to an upper right side of the dust collecting container 17.

The outer shell 3 is provided with a first protrusion portion 32 and a second protrusion portion 35 that are located on left and right sides of the outer shell 3, the first protrusion portion 32 is located on a side, corresponding to the first buckle 90, of the outer shell 3, the second protrusion portion 35 is located on a side, corresponding to the second buckle 91, of the outer shell 3, the first concave portion 33 is concavely arranged on the first protrusion portion 32, the second concave portion 36 is concavely arranged on the second protrusion portion 35, the fourth noise reducer 71 is located inside the first protrusion portion 32, the fifth noise reducer 72 is located inside the second protrusion portion 35. Through the above design, internal spaces of the first protrusion portion 32 and the second protrusion portion 35 are fully used, and the fourth noise reducer 71 and the fifth noise reducer 72 are arranged more easily.

The first protrusion portion 32 is provided with a first outer side wall 340 and a second outer side wall 341 that are located on front and rear sides of the first protrusion portion 32, and a first top side wall 342 located on a top of the first protrusion portion 32, the fourth noise reducer 71 is located between the first outer side wall 340 and the second outer side wall 341, the fourth noise reducer 71 is plate-shaped facing the air inlet window 330, a front side edge of the fourth noise reducer 71 abuts on the first outer side wall 340, a rear side edge of the fourth noise reducer 71 abuts on the second outer side wall 341, an upper side edge of the fourth noise reducer 71 abuts on the first top side wall 342, a bottom side edge of the fourth noise reducer 71 abuts on the lower cover 5. Through the above design, tightness between each side edge of the fourth noise reducer 71 and each side wall (341, 342, 343) of the first protrusion portion 32 is able to be enhanced, as well as with the lower cover 5; the noise reduction effect is able to be improved, and position stability of the fourth noise reducer 71 is also able to be enhanced; the second protrusion portion 35 is provided with a third outer side wall 370 and a fourth outer side wall 371 that are located on front and rear sides of the second protrusion portion 35, and a second top side wall 372 located on a top of the second protrusion portion 35, the fifth noise reducer 72 is located between the third outer side wall 370 and the fourth outer side wall 371, the fifth noise reducer 72 is plate-shaped facing the air outlet window 360, a front side edge of the fifth noise reducer 72 abuts on the third outer side wall 370, a rear side edge of the fifth noise reducer 72 abuts on the fourth outer side wall 371, an upper side edge of the fifth noise reducer 72 abuts on the second top side wall 372, a bottom side edge of the fifth noise reducer 72 abuts on the lower cover 5. Through the above design, sealing between each side edge of the fifth noise reducer 72 and each the side wall (371, 372, 373) of the second protrusion portion 35 is able to be enhanced, as well as with the lower cover 5; the noise reduction effect is able to be improved, and position stability of the fifth noise reducer 72 is also able to be enhanced. A lower end of the first outer side wall 340, a lower end of the second outer side wall 341, a lower end of the third outer side wall 370, a lower end of the fourth outer side wall 371, a lower end of the air inlet window 330 and a lower end of the air outlet window 360 are attached to the lower cover 5 separately.

The fourth noise reducer 71 is located on a lower side of the first top side wall 342, the fifth noise reducer 72 is located on a lower side of the second top side wall 372, the outer shell 3 is provided with at least one third positioning portion 380 for fixing the fourth noise reducer 71, and at least one fourth positioning portion 381 for fixing the fifth noise reducer 72, the at least one third positioning portion 380 is located inside the first protrusion portion 32 and integrally extends downward from the first top side wall 342, the at least one fourth positioning portion 381 is located inside the second protrusion portion 35 and integrally extends downward from the second top side wall 372.

The fourth noise reducer 71 is plate-shaped and is shielded on an inner side of the air inlet window 330, the fifth noise reducer 72 is plate-shaped and is shielded on an inner side of the air outlet window 360; the at least one third positioning portion 380 and the air inlet window 330 clamp the fourth noise reducer 71, the at least one fourth positioning portion 381 and the air outlet window 360 clamp the fifth noise reducer 72.

The air inlet window 330 is provided with a plurality of first grid plates 331 in parallel, the plurality of first grid plates 331 are located on a side, facing away from the first buckle 90, of the air inlet window 330, the air outlet window 360 is provided with a plurality of second grid plates in parallel, the plurality of second grid plates are located on a side, facing away from the second buckle 91, of the air outlet window 360, the at least one third positioning portion 380 and the plurality of first grid plates 331 clamp the fourth noise reducer 71, the at least one fourth positioning portion 381 and the plurality of second grid plates clamp the fifth noise reducer 72.

The vacuum cleaner further includes a heat dissipation duct 80, the motor 10 is provided with a heat dissipation air inlet 101 and a heat dissipation air outlet 102, the heat dissipation airflow enters the motor 10 from the heat dissipation air inlet 101 and is discharged out of the motor 10 from the heat dissipation air outlet 102 so as to flow into the heat dissipation duct 80, an end of the heat dissipation duct 80 is provided with an air outlet 800, the air outlet window 360 is located downstream of the air outlet 800 of the heat dissipation duct 80, the heat dissipation duct 80 is in fluid communication between the heat dissipation air outlet 102 of the motor 10 and an interior of the second protrusion portion 35.

The air outlet 800 of the heat dissipation duct 80 and the air outlet window 360 are located on left and right sides of the second protrusion portion 35, the air outlet 800 of the heat dissipation duct 80 is toward the air outlet window 360, the air outlet 800 of the heat dissipation duct 80 is in direct communication with the interior of the second protrusion portion 35. The above design is conducive to improvement in air outlet efficiency.

The vacuum cleaner further includes a heat dissipation air hood 81 for forming the heat dissipation duct 80, a sealing washer 82, and an accessory bag assembly 83, an outline of the heat dissipation air hood 81 is generally whistle-shaped; the accessory bag assembly 83 is mounted on the dust collecting container 17, the air outlet 800 of the heat dissipation duct 80 is located on an end, close to the air outlet window 360, of the heat dissipation air hood 81, the heat dissipation air hood 81 is provided with a sleeve ring portion 810. The sealing washer 82 is sleeved on an upper end of the motor 10 and is sealed between the sleeve ring portion 810 and a circumferential edge of the upper end of the motor 10, so as to isolate the heat dissipation air inlet 101 of the motor 10 from the heat dissipation duct 80. In this way, the situation that the heat dissipation airflow does not flow into the heat dissipation air inlet 101 and escapes into the heat dissipation duct 80 from a space between a periphery of the upper end of the motor 10 and the sleeve ring portion 810 is prevented.

The heat dissipation air outlet 102 of the motor 10 is located on a bottom side of the motor 10, the heat dissipation duct 80 includes an annular part 801 surrounding the motor 10 and a leading-out part 802 located downstream of the annular part 801, and with respect to the air outlet window 360, the air outlet 800 of the heat dissipation duct 80 is located on an end, close to the air outlet window 360, of the leading-out part 802, and with respect to the annular part 801, the air outlet 800 of the heat dissipation duct 80 is located on an end, away from the annular part 801, of the leading-out part 802.

The first concave portion 33 is provided with a first groove 332, the second concave portion 36 is provided with a second groove 362, the first groove 332 is located on a side, facing the first buckle 90, of the air inlet window 330, the second groove 362 is located on a side, facing the second buckle 91, of the air outlet window 360, the first buckle 90 is at least partially accommodated in the first groove 332, the second buckle 91 is at least partially accommodated in the second groove 362, the air inlet window 330 is in direct communication with the first groove 332 and an interior of the first protrusion portion 32, the air outlet window 360 is in direct communication with the second groove 362 and the interior of the second protrusion portion 35; the heat dissipation airflow enters the first protrusion portion 32 through the first groove 332 and the air inlet window 330 in sequence and passes through the fourth noise reducer 71 inside the first protrusion portion 32, the heat dissipation airflow downwardly passes through the interior of the motor 10 from the heat dissipation air inlet 101 and flows out of the motor 10 from the heat dissipation air outlet 102 on the bottom side of the motor 10; the heat dissipation airflow, after flowing out of the heat dissipation air outlet 102, enters the annular part 801 of the heat dissipation duct 80, the heat dissipation airflow flows upward to an upper part of the annular part 801 and is converged into the leading-out part 802 of the heat dissipation duct 80, and is discharged out of the heat dissipation duct 80 from the air outlet 800 of the heat dissipation duct 80 so as to enter the second protrusion portion 35, the heat dissipation airflow passes through the fifth noise reducer 72 inside the second protrusion portion 35 and is discharged through the air outlet window 360.

What is claimed is:

1. A vacuum cleaner, comprising a motor, an impeller being able to be driven by the motor to rotate so as to generate a suction airflow, an exhaust air duct, an air window wall for ventilation, a first noise reducer which is breathable, and a second noise reducer which is breathable, a tail end of the exhaust air duct is provided with an air duct outlet for air exhaust of the exhaust air duct, the air window wall is located downstream of the air duct outlet, the first noise reducer blocks the exhaust air duct, the second noise reducer is shielded on an inner side of the air window wall, and an airflow discharged by the impeller flows through the exhaust air duct and sequentially passes through the first noise reducer, the second noise reducer, and the air window wall.

2. The vacuum cleaner according to claim 1, wherein the vacuum cleaner further comprises an expansion chamber located downstream of the air duct outlet, the second noise reducer is located inside the expansion chamber, and an airflow output by the air duct outlet is discharged into the expansion chamber and sequentially passes through the second noise reducer and the air window wall so as to be discharged out of the expansion chamber; and the airflow output by the air duct outlet spreads in the expansion chamber, and the air duct outlet constitutes an air inlet of the expansion chamber.

3. The vacuum cleaner according to claim 2, wherein the air window wall is exposed to an outer side of the vacuum cleaner, the air window wall is in communication with an exterior of the vacuum cleaner and the expansion chamber, the air window wall is provided with a first air window, a second air window and an airtight baffle connected between the first air window and the second air window, the first air window is located on a side, close to the air duct outlet, of the airtight baffle, the second air window is located on a side, away from the air duct outlet, of the airtight baffle, the second noise reducer abuts on an inner side of the first air window, an inner side of the second air window and an inner side of the airtight baffle, the second noise reducer completely shields the first air window and the second air window, and the airflow discharged from the air duct outlet into the expansion chamber is discharged out of the expansion chamber through the first air window and the second air window; and/or
the vacuum cleaner further comprises a handle and an outer shell, the handle is located on an outer side of the outer shell and is connected with the outer shell, the air window wall is arranged on the outer shell, the outer shell is provided with at least one first positioning portion extending downward, the at least one first positioning portion and the air window wall clamp the second noise reducer, and the at least one first positioning portion is located inside the expansion chamber; and/or
the first noise reducer is arranged at the air duct outlet, and the air duct outlet is toward the air window wall.

4. (canceled)

5. The vacuum cleaner according to claim 12, wherein the exhaust air duct is provided with an inner duct, an outer duct connected with the inner duct, and a partition wall, the inner duct is annular around an axis of a rotating shaft of the motor, the impeller is able to be driven by the rotating shaft of the motor to rotate, the outer duct surrounds the inner duct, the outer duct is located downstream of the inner duct, an end of the outer duct constitutes the air duct outlet, an opposite end of the outer duct is in direct communication with the inner duct, and the partition wall is shared by the inner duct and the outer duct so as to separate the inner duct from the outer duct.

6. The vacuum cleaner according to claim 5, wherein the end, constituting the air duct outlet, of the outer duct constitutes a tail end of the exhaust air duct, and the first noise reducer blocks the end, constituting the air duct outlet, of the outer duct, so as to block the exhaust air duct; and/or
the partition wall is airtight, so as to prevent air in the inner duct from entering the outer duct through the partition wall, and an airflow conveyed by the exhaust air duct is all discharged out of the exhaust air duct from the air duct outlet and all passes through the first noise reducer; and/or
the first noise reducer blocks the outer duct.

7. (canceled)

8. (canceled)

9. The vacuum cleaner according to claim 5, wherein the exhaust air duct constitutes a spiral duct, the vacuum cleaner further comprises a spiral side wall for forming the spiral duct, the spiral side wall is provided with a circumferential wall for being surrounded to form the inner duct and an outer connection wall connected with the circumferential wall, the circumferential wall is in a non-closed annular shape, the partition wall belongs to the circumferential wall, the partition wall is further configured for forming the outer duct with the outer connection wall, an end of the partition wall is a free end and constitutes an end of the circumferential wall, an opposite end of the circumferential wall is connected with an end of the outer connection wall, and an air outlet of the inner duct is formed between the opposite end of the circumferential wall and the free end of the partition wall, the air outlet of the inner duct constitutes an air inlet of the outer duct, an air outlet of the outer duct is formed between an opposite end of the outer connection wall and an opposite end of the partition wall, and the air outlet of the outer duct constitutes the air duct outlet.

10. The vacuum cleaner according to claim 9, wherein the partition wall, the outer connection wall and the outer duct are arc-shaped, and the circumferential wall surrounds the axis of the rotating shaft of the motor; and/or
the vacuum cleaner further comprises an outer shell, the outer shell is located on the upper side of the lower cover and covers the exhaust air hood, the air window wall is arranged on the outer shell, and a lower end edge of the air window wall is attached to the lower cover; the lower cover is provided with a suction air port, a bottom plate and an annular wall for being surrounded to form the lower annular part, the suction airflow flows through the suction air port, the suction air port penetrates through upper and lower sides of the bottom plate, the bottom plate constitutes a bottom wall of the lower annular part, the impeller shell is located between a lower end of the middle cylinder wall and the bottom plate, and the plurality of first extending portions and the bottom plate clamp the third noise reducer along an up-down direction; and the annular wall extends upward from a circumferential edge of the bottom plate, the circumferential wall couples with the annular wall along the up-down direction, the circumferential wall constitutes an outer circumferential wall of the upper annular part, and the annular wall constitutes an outer circumferential wall of the lower annular part.

11. The vacuum cleaner according to claim 9, wherein the vacuum cleaner further comprises a lower cover and an exhaust air hood, the exhaust air hood is located on an upper side of the lower cover, the exhaust air duct is formed between the exhaust air hood and the lower cover, and the spiral side wall belongs to the exhaust air hood; and the vacuum cleaner further comprises an impeller shell and a third noise reducer, the impeller is located inside the impeller shell, the impeller shell is located between the exhaust air hood and the lower cover, the impeller shell is provided with a plurality of exhaust air outlets located along a circumferential direction thereof, the airflow discharged by the impeller enters the inner duct through the plurality of exhaust air outlets, the third noise reducer is located inside the inner duct, the third noise reducer is sleeved around a periphery of the impeller shell to shield the plurality of exhaust air outlets, the exhaust air hood is provided with a plurality of first extending portions, the plurality of first extending portions are located inside the inner duct and on an upper side of the third noise reducer, and the plurality of first extending portions extend downward and abut against the third noise reducer.

12. The vacuum cleaner according to claim 11, wherein the inner duct comprises an upper annular part and a lower annular part, the upper annular part is formed in the exhaust air hood, the lower annular part surrounds the impeller shell, the third noise reducer is located inside the lower annular part, the lower annular part is in direct communication with the plurality of exhaust air outlets, the airflow discharged by the impeller enters the lower annular part through the plurality of exhaust air outlets and flows upward into the upper annular part, and the plurality of first extending portions are each at least partially accommodated in the upper annular part;
the vacuum cleaner further comprises a dust collecting container, the lower cover covers an upper end of the dust collecting container, the motor is vertically arranged on the upper side of the lower cover, the exhaust air hood is further provided with a middle cylinder wall, the middle cylinder wall surrounds the motor, the middle cylinder wall constitutes an inner circumferential wall of the upper annular part, the plurality of first extending portions are distributed on a periphery of the middle cylinder wall, and the plurality of first extending portions extend downward from a top side of the upper annular part.

13. (canceled)

14. (canceled)

15. The vacuum cleaner according to claim 5, wherein the exhaust air duct constitutes a spiral duct, the vacuum cleaner further comprises a spiral side wall for forming the spiral duct, the spiral side wall is provided with a circumferential wall for being surrounded to form the inner duct and an outer connection wall connected with the circumferential wall, the circumferential wall is in a non-closed annular shape, the partition wall belongs to the circumferential wall, the partition wall is further configured for forming the outer duct with the outer connection wall; an airflow output by the air duct outlet is discharged into the expansion chamber, and the distal wall, the expansion chamber and the air duct outlet are located on a periphery of the circumferential wall; and the spiral duct surrounds the axis of the rotating shaft of the motor, the air window wall constitutes an outer wall of the expansion chamber relative to an exterior of the vacuum cleaner, a part of the circumferential wall is opposite to the air window wall along a radial direction of the rotating shaft of the motor, the part of the circumferential wall and the air window wall are located on the same side of the motor, the distal wall is opposite to the air duct outlet along a circumferential direction around the inner duct, the distal wall connects the circumferential wall to the air window wall, and the distal wall constitutes a side wall of the expansion chamber and is located on an end, away from the air duct outlet, of the expansion chamber.

16. The vacuum cleaner according to claim 15, wherein the vacuum cleaner further comprises a lower cover and an exhaust air hood, the exhaust air hood is located on an upper side of the lower cover, the exhaust air duct is formed between the exhaust air hood and the lower cover, the spiral side wall belongs to the exhaust air hood, the exhaust air hood is further provided with a top plate and a spiral top wall for forming the spiral duct, and the spiral side wall is integrally connected with the spiral top wall; the distal wall belongs to the exhaust air hood, the top plate covers a top side of the expansion chamber, the top plate is integrally connected with a top edge of the distal wall, the first noise reducer is arranged at the air duct outlet, a bottom surface A of an end, adjacent to the air duct outlet, of the spiral top wall is lower than a bottom surface B, adjacent to the air duct outlet, of an end of the top plate, and a blocking wall is connected between the bottom surface A and the bottom surface B; and the blocking wall blocks a side, facing the exhaust air duct, of the first noise reducer to prevent the first noise reducer from escaping inward the spiral duct, and a top of the first noise reducer is higher than the bottom surface A and abuts on the bottom surface B;
the vacuum cleaner further comprises at least one second positioning portion, the at least one second positioning portion integrally extends downward from the top plate, and the at least one second positioning portion blocks a side, facing away from the outer duct, of the first noise reducer to prevent the first noise reducer from leaving the air duct outlet under an impact of airflow in the exhaust air duct; and the spiral top wall is in a spiral rising state, an end, adjacent to the air duct outlet, of the spiral top wall is higher than an opposite end of the spiral top wall, and the opposite end of the spiral top wall is integrally connected with the free end of the partition wall.

17. (canceled)

18. (canceled)

19. The vacuum cleaner according to claim 12, wherein the vacuum cleaner further comprises at least one second positioning portion, the first noise reducer is arranged at a predetermined position of the exhaust air duct, and the at least one second positioning portion blocks a side of the first noise reducer to prevent the first noise reducer from leaving the predetermined position under an impact of airflow in the exhaust air duct;
the predetermined position is the air duct outlet, and the at least one second positioning portion blocks a downstream side of the first noise reducer;
the at least one second positioning portion is arranged as spaced-apart extension columns.

20. (canceled)

21. (canceled)

22. (canceled)

23. The vacuum cleaner according to claim 12, wherein the vacuum cleaner further comprises an air inlet window, an air outlet window, a fourth noise reducer which is breathable and corresponds to the air inlet window, and a fifth noise reducer which is breathable and corresponds to the air outlet window, a heat dissipation airflow for the motor enters the vacuum cleaner through the air inlet window and is discharged out of the vacuum cleaner through the air outlet window, the heat dissipation airflow sequentially passes through the air inlet window, the fourth noise reducer, an interior of the motor, the fifth noise reducer, and the air outlet window, the motor is provided with a heat dissipation fan, and the heat dissipation fan rotates to drive air to flow to form the heat dissipation airflow;
the vacuum cleaner further comprises a dust collecting container, an outer shell, a lower cover, a first buckle and a second buckle, the lower cover covers an upper end of the dust collecting container, the dust collecting container and the lower cover are detachably assembled together by the first buckle and the second buckle, the first buckle is buckled at an edge of a side of the lower cover, the second buckle is buckled at an edge of an opposite side of the lower cover, the outer shell is mounted on an upper side of the lower cover, an air inlet window and an air outlet window are located on left and right sides of the outer shell; and the outer shell is further provided with a first concave portion and a second concave portion, the first concave portion and the second concave portion are located on left and right sides of the outer shell, the first buckle is at least partially accommodated in the first concave portion, the second buckle is at least partially accommodated in the second concave portion, the first concave portion is provided with the air inlet window, the second concave portion is provided with the air outlet window, a fourth noise reducer is located on a side, facing away from the first buckle, of the air inlet window, and a fifth noise reducer is located on a side, facing away from the second buckle, of the air outlet window.

24. (canceled)

25. The vacuum cleaner according to claim 23, wherein the vacuum cleaner further comprises a handle, the handle is connected with the outer shell, and the air window wall is arranged on a front or rear side of the outer shell, the outer shell is provided with a first protrusion portion and a second protrusion portion that are located on left and right sides of the outer shell, the first protrusion portion is located on a side, corresponding to the first buckle, of the outer shell, the second protrusion portion is located on a side, corresponding to the second buckle, of the outer shell, the first concave portion is concavely arranged on the first protrusion portion, the second concave portion is concavely arranged on the second protrusion portion, the fourth noise reducer is located inside the first protrusion portion, and the fifth noise reducer is located inside the second protrusion portion;
the first concave portion is formed with a first groove, the second concave portion is formed with a second groove, the first groove is located on a side, facing away from the fourth noise reducer, of the air inlet window; the second groove is located on a side, facing away from the fifth noise reducer, of the air outlet window, the first buckle is at least partially accommodated in the first groove, the second buckle is at least partially accommodated in the second groove, the air inlet window is in direct communication with the first groove and an interior of the first protrusion portion, and the air outlet window is in direct communication with the second groove and the interior of the second protrusion portion.

26. The vacuum cleaner according to claim 25, wherein the first protrusion portion is provided with a first outer side wall and a second outer side wall that are located on front and rear sides thereof, and a first top side wall located on a top of the first protrusion portion, the fourth noise reducer is located between the first outer side wall and the second outer side wall, the fourth noise reducer is plate-shaped facing the air inlet window, a front side edge of the fourth noise reducer abuts on the first outer side wall, a rear side edge of the fourth noise reducer abuts on the second outer side wall, an upper side edge of the fourth noise reducer abuts on the first top side wall, and a bottom side edge of the fourth noise reducer abuts on the lower cover; and the second protrusion portion is provided with a third outer side wall and a fourth outer side wall that are located on front and rear sides thereof, and a second top side wall located on a top of the second protrusion portion, the fifth noise reducer is located between the third outer side wall and the fourth outer side wall, the fifth noise reducer is plate-shaped facing the air outlet window, a front side edge of the fifth noise reducer abuts on the third outer side wall, a rear side edge of the fifth noise reducer abuts on the fourth outer side wall, an upper side edge of the fifth noise reducer abuts on the second top side wall, a bottom side edge of the fifth noise reducer abuts on the lower cover, and a lower end of the first outer side wall, a lower end of the second outer side wall, a lower end of the third outer side wall, a lower end of the fourth outer side wall, a lower end of the air inlet window and a lower end of the air outlet window are attached to the lower cover separately.

27. The vacuum cleaner according to claim 25, wherein the first protrusion portion is further provided with a first top side wall located on a top of the first protrusion portion, the second protrusion portion is further provided with a second top side wall located on a top of the second protrusion portion, the fourth noise reducer is located on a lower side of the first top side wall, the fifth noise reducer is located on a lower side of the second top side wall, the outer shell is provided with at least one third positioning portion for fixing the fourth noise reducer, and at least one fourth positioning portion for fixing the fifth noise reducer, the at least one third positioning portion is located inside the first protrusion portion and integrally extends downward from the first top side wall, and the at least one fourth positioning portion is located inside the second protrusion portion and integrally extends downward from the second top side wall.

28. The vacuum cleaner according to claim 23, wherein the fourth noise reducer is plate-shaped and is shielded on an inner side of the air inlet window, and the fifth noise reducer is plate-shaped and is shielded on an inner side of the air outlet window; and the outer shell is provided with at least one third positioning portion for fixing the fourth noise reducer, and at least one fourth positioning portion for fixing the fifth noise reducer, the at least one third positioning portion and the air inlet window clamp the fourth noise reducer, and the at least one fourth positioning portion and the air outlet window clamp the fifth noise reducer.

29. The vacuum cleaner according to claim 28, wherein the air inlet window is provided with a plurality of first grid plates in parallel, the plurality of first grid plates are located on the side, facing away from the first buckle, of the air inlet window, the air outlet window is provided with a plurality of second grid plates in parallel, the plurality of second grid plates are located on the side, facing away from the second buckle, of the air outlet window, the at least one third positioning portion and the plurality of first grid plates clamp the fourth noise reducer, and the at least one fourth positioning portion and the plurality of second grid plates clamp the fifth noise reducer.

30. The vacuum cleaner according to claim 25, wherein the vacuum cleaner further comprises a heat dissipation duct, the motor is provided with a heat dissipation air inlet and a heat dissipation air outlet, the heat dissipation airflow enters the motor from the heat dissipation air inlet and is discharged out of the motor from the heat dissipation air outlet so as to flow into the heat dissipation duct, an end of the heat dissipation duct is provided with an air outlet, the air outlet window is located downstream of the air outlet of the heat dissipation duct, and the heat dissipation duct is in fluid communication between the heat dissipation air outlet of the motor and an interior of the second protrusion portion;
the air outlet of the heat dissipation duct and the air outlet window are located on left and right sides of the second protrusion portion, the air outlet of the heat dissipation duct is toward the air outlet window.

31. (canceled)

32. The vacuum cleaner according to claim 3130, wherein the air outlet of the heat dissipation duct is in direct communication with the interior of the second protrusion portion, and the vacuum cleaner further comprises a heat dissipation air hood for forming the heat dissipation duct and a sealing washer, the air outlet of the heat dissipation duct is located on an end, close to the air outlet window, of the heat dissipation air hood, the heat dissipation air hood is provided with a sleeve ring portion, and the sealing washer is sleeved on an upper end of the motor and is sealed between the sleeve ring portion and a circumferential edge of the upper end of the motor, so as to isolate the heat dissipation air inlet of the motor from the heat dissipation duct;
the heat dissipation air outlet of the motor is located on a bottom side thereof, the heat dissipation duct comprises an annular part surrounding the motor and a leading-out part located downstream of the annular part, and with respect to the air outlet window, the air outlet of the heat dissipation duct is located on an end, close to the air outlet window, of the leading-out part; and with respect to the annular part, the air outlet of the heat dissipation duct is located on an end, away from the annular part with, of the leading-out part;
the heat dissipation airflow enters the first protrusion portion through the first groove and the air inlet window in sequence and passes through the fourth noise reducer inside the first protrusion portion, the heat dissipation airflow downwardly passes through the interior of the motor from the heat dissipation air inlet and flows out of the motor from the heat dissipation air outlet on the bottom side of the motor; the heat dissipation airflow, after flowing out of the heat dissipation air outlet, enters the annular part of the heat dissipation duct; the heat dissipation airflow flows upward to an upper part of the annular part and is converged into the leading-out part of the heat dissipation duct, and is discharged out of the heat dissipation duct from the air outlet of the heat dissipation duct so as to enter the second protrusion portion, and the heat dissipation airflow passes through the fifth noise reducer inside the second protrusion portion and is discharged through the air outlet window.

33. (canceled)

34. (canceled)

35. (canceled)
